(19) United States
(12) Patent Application Publication
(10) Pub. No.: US 2009/0091050 A1
(43) Pub. Date: Apr. 9, 2009

(54) APPARATUS AND METHOD FOR BARRIER LAYER EXISTENCE DETERMINATION USING FLUORESCENCE MEASUREMENTS

(76) Inventors: Donald E Zelonis, Manchester, NH (US); Sam Kalmouni, Pembroke, NH (US)

Correspondence Address: MILES & STOCKBRIDGE PC, 1751 PINNACLE DRIVE, SUITE 500, MCLEAN, VA, 22102-3833, US

(21) Appl. No.: 11/867,881

(22) Filed: Oct. 5, 2007

(51) Int. Cl. C09K 11/00

(52) U.S. Cl. 264/21

(57) ABSTRACT

A fabrication method is provided for forming a multilayer preform with a barrier layer and determining the existence of the barrier layer in the multilayer preform. The barrier layer may consist essentially of a polymeric material without any optical brighteners. The multilayer preform may be illuminated with ultra-violet (UV) light. The fluorescence caused by the interaction of the UV light with the multilayer preform may be measured to generate a fluorescence signal. Based on the fluorescence signal, the existence of the barrier layer in the multilayer preform may be determined.

The present invention relates generally to fluorescence detection of layers, and, more particularly, to layer existence verification in a multilayer preform.

Polymers are commonly extruded or injection molded to make films, sheets, preforms, and other molded articles useful for a wide range of applications including containers such as bottles and cups, wrappers for packaging, various displays, signs, and multiple other products. Often additional layers are co-extruded or molded with a base layer to improve certain properties of the molded articles. Other times additional layers are coated onto a base layer. These additional layers can be made from a different material than the base layer to improve particular properties such as barrier properties which limit migration of various liquids or gases. Multilayer plastic containers often contain a thin barrier layer to provide a barrier against migration of gases such as carbon dioxide or oxygen. To make these multilayer containers, multilayer preforms are used. The preform is typically blow molded to make the container. Any non-uniformity such as a missing barrier layer or a gap in the barrier layer could substantially degrade the barrier properties thereby significantly decreasing the performance of the resultant container.

While the different layers may have unique chemical formulations and contribute unique performance attributes to the overall container, the various components of a multilayer plastic container will most likely have very similar optical properties, at least within the visible range of the electromagnetic spectrum. More specifically, the index of refraction and optical transmission of these different materials are generally quite similar. This optical similarity is not accidental. In order to maintain the look consumers have become accustomed to with regard to plastic food and beverage containers, the manufacturers have, during the formulation of suitable multilayer components, been careful to maintain constant optical properties of the polymers.

This fact is significant in relation to the process of automated inspection of multilayer plastic containers. Many prior art machine vision systems utilize charge-coupled device (CCD) cameras sensitive to radiation in the visible wavelength range and a suitable visible light source operated as a backlight. In this fashion, the structural integrity of the container is checked for manufacturing flaws. Because the various layers of a multilayer plastic container all have very similar optical properties in the visible wavelength range, the selective inspection of the individual layers of a multilayer container could be extremely hard to do using state-of-the-art machine vision solutions. While it would be possible to detect a defect extending through the container wall, the ability to detect the presence or absence of a layer type, in part or in whole, could be difficult. The similar optical properties of the corresponding layers and the directly resulting lack of image contrast make layer-specific inspection virtually impossible using state-of-the-art technology.

Because of the difficulty in visually examining layers in a preform, quality control of the preforms has been exercised by cutting the preform and visually inspecting the cross-section to determine the existence of the barrier layer. This method is a selectively destructive test which requires manual intervention and practically prohibits testing of the entire lot of manufactured preforms. Ultrasonic methods have also been employed to inspect barrier layers of a preform; however, such methods are costly and do not afford sufficient speed to keep up with the part-per-hour rate of typical fabrication systems. Embodiments of the present invention may address the above-mentioned problems and limitations, among other things.

### SUMMARY OF THE INVENTION

An embodiment of the present invention may include a fabrication method including forming a plurality of multilayer preforms using a preform manufacturing apparatus. Each multilayer preform may have a barrier layer, which may consist essentially of a polymeric material without any optical brighteners. The polymeric material may be selected from polyamides and ethylene vinyl alcohol copolymers. A test wheel can be provided on-line following the preform manufacturing apparatus and on-line preceding a molding apparatus, which forms the multilayer preforms into containers. The test wheel may have a plurality of test stations radially disposed around its circumference. The test wheel may rotate about its center to enable loading and unloading of test stations. Each test station can receive a multilayer preform for evaluation and can have a positioning means, an illumination means, and a detection means. A preform may be loaded into one of the test stations and may be illuminated with ultra-violet (UV) light from the illumination means. The preform may be rotated with respect to the illumination means. The fluorescence caused by the interaction of the UV light with the preform can be measured by the detection means to generate a fluorescence signal. The existence of the barrier layer may be determined based on the fluorescence signal. The multilayer preform may be marked or rejected when the barrier layer is determined not to exist. The test apparatus may be rotated simultaneously with the testing to allow loading of a next test station with a multilayer preform. The process may be repeated for a plurality of multilayer preforms.

Another embodiment may include a fabrication method including forming a multilayer preform with a barrier layer. The barrier layer can consist essentially of a polymeric material without any optical brighteners. The multilayer preform can be illuminated with ultra-violet (UV) light. The fluorescence caused by the interaction of the UV light with the multilayer preform can be measured to generate a fluorescence signal. Based on the fluorescence signal, the existence of the barrier layer in the multilayer preform can be determined.

### BRIEF DESCRIPTION OF DRAWINGS

FIG. 1 shows a simplified block diagram of the cross-section of a multi-layer preform;

FIG. 2 shows a block diagram of a first embodiment according to aspects of the invention;

FIG. 3 shows a block diagram of a second embodiment according to aspects of the invention;

FIG. 4 shows a block diagram of a third embodiment according to aspects of the invention;

FIG. 5 shows a block diagram of a fourth embodiment according to aspects of the invention;

FIG. 6 shows a block diagram of a fifth embodiment according to aspects of the invention;

FIG. 7 shows a block diagram of a sixth embodiment according to aspects of the invention; and

FIG. 8 shows a flow chart of an exemplary method according to aspects of the invention for forming and evaluating a multilayer preform.

### DETAILED DESCRIPTION

Throughout the Figures, like elements have been identified by the use of like numerals. It is further noted that the Figures have not been drawn to scale, and the particular orientation and relationship of components is only exemplary in nature.

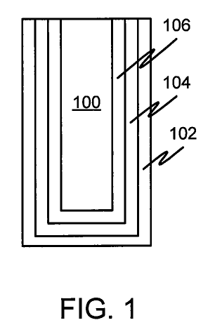

FIG. 1 is a cross-sectional view of a multilayer preform 100. The multilayer preform may be used as the starting material in the manufacture of hollow plastic containers. The term “preform” refers to tubular structures closed at one end, which can be molded into bottles or other generally cylindrical containers. As used in the context of this application, the term “preform” is intended to include structures commonly used in the art generally described as preforms, parisons, and other similar structures.

The multilayer preform may be formed by any means known in the art. These methods may include extrusion, co-extrusion, injection blow molding, co-injection blow molding, extrusion blow molding, co-extrusion blow molding, stretch blow molding, solution coating, spin blowing, lamination processes, injection molding, co-injection molding, and combinations thereof. In an exemplary embodiment, the multilayer preform is formed by injection molding. After injection molding, the preform may be reheated and molded to form a hollow container.

The multilayer preform 100 may have a plurality of layers 102, 104, and 106, including at least one barrier layer 104. Although three layers are shown, the preform may have additional or fewer layers depending on the application. The barrier layer 104 provides permeation resistance to water, oxygen, or other substances. Layers 102 and 106 may provide structural integrity or other functions for the final hollow container. Layers 102 and 106 may be basic polymers, such as polypropylene (PP), high density polyethylene (HDPE), polyvinylchloride (PVC), polyethylene teraphthalate (PET) or other polymeric or nonpolymeric materials commonly used in the art. In an exemplary embodiment, the barrier layer 104 may be a polymeric material without any optical brighteners. The term “optical brightener” as used herein refers to fluorescent additives, fluorescent dyes, fluorophores, luminophores, and the like that upon addition to the polymeric material would substantially affect the native fluorescence of the polymeric material upon exposure to ultra-violet (UV) light. Non-fluorescent additives may be incorporated into the polymeric material to influence certain properties of the polymeric material, such as to improve the adhesion properties of the barrier layer. The barrier layer may be a polymeric material selected from polyamides and ethylene vinyl alcohol copolymers. An exemplary polyamide for use as the barrier layer 104 may be nylon.

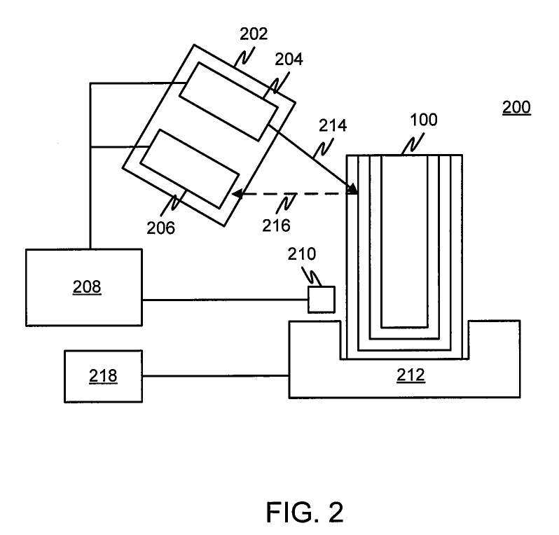

FIG. 2 shows an exemplary embodiment 200 for testing a single multilayer preform 100. The multilayer preform 100 may be positioned in front of a layer sensor 202 via a positioner 212. Controller 218 may control the operation of the positioner 212. The positioner may be a conveyance mechanism that allows for the movement of a plurality of preforms past the layer sensor. Conveyance mechanisms are well known in the art and will not be discussed in detail herein. Proximity sensor 210 may be used to indicate when a preform is in position for evaluation by the layer sensor 202. Alternately, the positioner may be a stationary fixture configured to position the preform 100 in front of the layer sensor 202 in a repeatable manner.

Layer sensor 202 can have a light source 204 and a fluorescence detector 206. Although shown as a single structure in FIG. 2, the components of the layer sensor may be provided separately. The light source 204 may generate ultra-violet (UV) light 214 and may direct the light 214 onto the preform 100 where it can interact with the barrier layer to cause fluorescence. The resultant fluorescence 216 may be directed to the fluorescence detector 206 so as to generate a fluorescence signal. The fluorescence signal may be sent to a processor 208, which can use the signal to determine the existence of the barrier layer in the multilayer preform. The light source 204, fluorescence detector 206, and positioner 212 may be oriented with respect to each other such that the light 214 from the source 204 is prevented from reflecting from the preform 100 into the fluorescence detector 206.

The light source 204 may be any source known in the art capable of generating UV light. In an exemplary embodiment, the light source may generate light having a wavelength between 320 nm and 400 nm. The source can be a light emitting diode (LED), a semiconductor laser, a solid-state laser, a gas laser, an arc lamp, or an incandescent lamp. In an exemplary embodiment, the light source may be a semiconductor-based UV light source.

The fluorescence detector 206 may be sensitive to the wavelengths at which the barrier layer fluoresces upon exposure to UV light. Any detector known in the art capable of sensing the resulting fluorescent light may be used. For example, the fluorescence detector may be sensitive to wavelengths between 350 nm and 1000 nm. Additionally, the detector 206 may employ means to specifically select a wavelength at which the barrier layer fluoresces. Such means may include a monochromator, bandpass filter, or other methods for wavelength selection known in the art. The detector 206 may also be calibrated or normalized to account for ambient or stray light which may adversely affect detection sensitivity. In an exemplary embodiment, the fluorescence detector is a single semiconductor photodiode.

The operation of the layer sensor 202 may be controlled by processor 208. Processor 208 may receive a signal from the proximity sensor 210 indicating that a preform 100 is in position for evaluation. The UV light 214 from the UV light source 204 may be continuously illuminated. Alternately, the UV light 214 may be pulsed to coincide with the movement of the preform 100 by the positioner 212. In such a scenario, the processor 208 can control the operation of the UV light source 204 accordingly, such that illumination of the UV light only occurs when a preform is in the proper position for evaluation.

The detector 206 may generate a fluorescence signal based on the detected fluorescent light 216, which may be communicated to the processor 208. Processor 208 can use the generation of the fluorescence signal to determine if the barrier layer exists. The processor 208 may further interact with the positioner 212 through controller 218 to position the next preform and/or direct an evaluated preform along a different path depending on the results of the determination. Although shown as separate structures, processor 208 and controller 218 may be combined into a single unit.

In an exemplary embodiment, the determination of the existence of the barrier layer may be based on a comparison of the fluorescence signal with a predetermined threshold. A fluorescence signal greater than or equal to the predetermined threshold would indicate the presence of the barrier layer while a fluorescence signal less than the predetermined threshold would indicate the absence of the barrier layer. The predetermined threshold may be determined by a calibration step using known samples with and without barrier layers. The predetermined threshold may be selected such that the occurrence of false positives or false negatives is minimized.

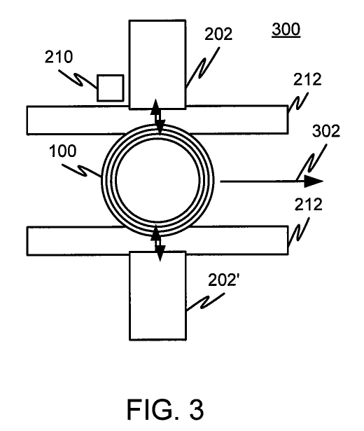

FIG. 3 shows another embodiment 300 for testing multilayer preforms. In FIG. 3, positioner 212 may be configured to move at least one preform 100 along a direction 302 past a layer sensor 202. Proximity sensor 210 may indicate the presence of the multilayer preform 100 in a position for evaluation by the layer sensor 202. In addition to layer sensor 202, a second layer sensor 202′ may be provided opposite the layer sensor 202. This second layer sensor 202′ can enable simultaneous detection of the barrier layer at a point on the opposite side of the preform.

In FIG. 3, the layer sensors 202, 202′ are shown positioned at 180° with respect to each other. However, different angles between the sensors are contemplated. Further, although only two layer sensors 202 and 202′ have been illustrated, any number of layer sensors may be disposed around the preform 100. For example, four layer sensors may be radially disposed equidistant about the circumference of the preform 100, thereby enabling testing of the existence of the barrier layer at four points on the preform simultaneously. Further, the layer sensors need not be disposed in a planar configuration about the preform 100. In another embodiment, multiple layer sensors may be disposed in a direction parallel to the longitudinal axis of the preform (i.e. perpendicular to the plane of FIG. 3), thereby enabling simultaneous testing at multiple points along the length of the preform.

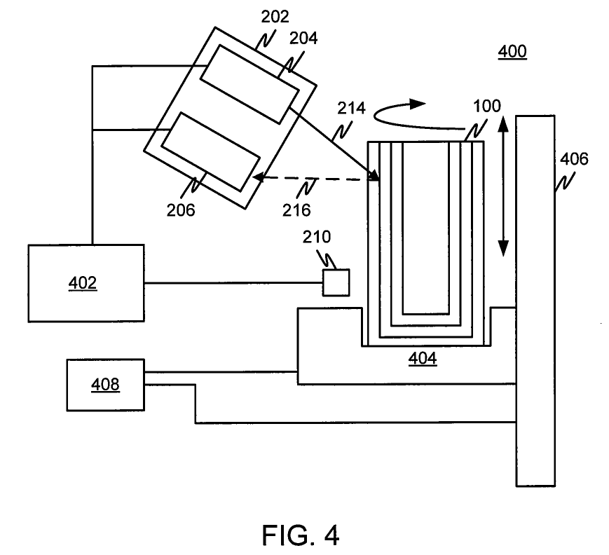

FIG. 4 shows another embodiment 400. As in previous embodiments, the layer sensor 202 may direct UV light 214 from the light source 204 onto the preform 100 with the resulting fluorescence 216 measured by a fluorescence detector 206. Proximity sensor 210 may provide a signal indicating the presence of a preform 100 in a location appropriate for sensing of the barrier layer. Processor 402 may receive location information from the proximity sensor and may control operation of the UV light source 204 based thereon. The fluorescence detector 206 may generate a fluorescence signal based on the magnitude of the fluorescence detected and may communicate the fluorescence signal to the processor 402.

In this embodiment 400, a rotation means 404 can be provided for rotating the preform about its longitudinal axis. A translation means 406 may also be provided for moving the preform in at least one dimension. The rotation and/or translation of the preform can enable illumination of multiple points on the preform 100 by the UV light 214. Rotation and translation mechanisms are well known in the art and will not be discussed in detail here. Controller 408 may control operation of the rotation and translation mechanisms. The processor 402 may further interact with the rotation means 404 and/or translation means 406 through controller 408 to position the preform 100 for testing. The processor 402 may control the source 204 to continuously illuminate the preform during rotation and/or translation and continuously measure the generated fluorescence using detector 206. Alternately, the illumination may be periodic to coincide with rotation and/or translation steps. Although shown as separate structures, processor 402 and controller 408 may be combined into a single unit. Conveyance means may additionally be included as a component of the rotation means 404 to enable positioning of subsequent preforms for testing. Further, although the preform is shown as being rotated and/or translated, rotation and/or translation means may be provided for the layer sensor 202 instead, such that the layer sensor 202 can be rotated and/or translated with respect to a stationary preform 100.

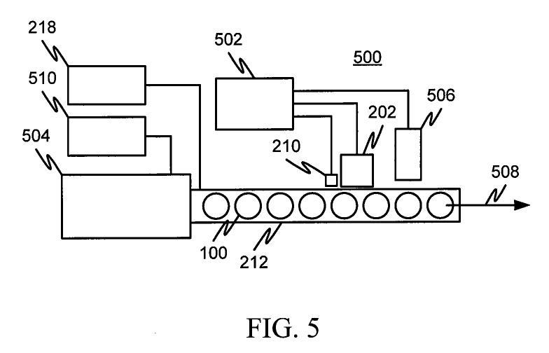

FIG. 5 illustrates another embodiment 500 of the layer sensor 202 that can be applied to the output of a manufacturing apparatus 504. The manufacturing apparatus 504 may be any machine known in the art for forming multilayer preforms 100. For example, the apparatus 504 may form the multilayer preform by a process such as extrusion, a co-extrusion, an injection blow molding, a co-injection blow molding, an extrusion blow molding, a co-extrusion blow molding, stretch blow molding, solution coating, spin blowing, lamination process, injection molding, co-injection molding, and combinations thereof. In an exemplary embodiment, the apparatus 504 is an injection molding machine.

The apparatus 504 may form a plurality of preforms 100 and may provide the preforms to positioner 212. As shown, the positioner 212 can be provided on-line with the output of the apparatus 504. Controller 218 may control the positioner 212 to convey the preforms 100 in direction 508 past the layer sensor 202 for evaluation. Proximity sensor 210 may indicate when the preform is in place for evaluation by the sensor 202. Processor 502 may receive a fluorescence signal from the layer sensor 202 and may determine the existence of the barrier layer in each preform based on the signal.

If the barrier layer is not present, processor 502 may control a marking device 506 to mark or tag the appropriate preform for subsequent action. The marking device 506 may be a laser, printer, labeler, or other devices known in the art for marking a product. Marking device 506 may be replaced with a rejection device for directing preforms without a barrier layer along a different path. Controller 510 may control operation of the manufacturing apparatus 504. Information from the processor 502 regarding presence of the barrier layer in the tested multilayer preforms 100 may be used as feedback to the controller 510 for use in adjusting operating parameters of the manufacturing device 504. Although shown as separate components, processor 502, controller 218, and controller 510 may be integrated into a single device. In FIG. 5, the layer sensor 202 has been shown configured in an on-line arrangement at the output of the manufacturing device 504. However, the layer sensor may also be provided in an off-line arrangement as a separate testing station for quality control of a batch of preforms from the manufacturing device 504.

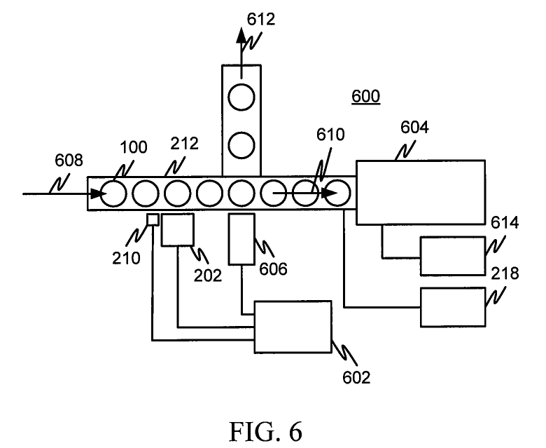

FIG. 6 illustrates an embodiment 600 of the layer sensor 202 that can be applied to a manufacturing apparatus 604, which further processes a preform 100. The manufacturing apparatus 604 may be any machine known in the art for processing a multilayer preform 100, such as a machine that forms the preform 100 into a multilayer container. For example, the apparatus 604 may be a molding apparatus performing a process such as injection blow molding, co-injection blow molding, extrusion blow molding, co-extrusion blow molding, stretch blow molding, solution coating, spin blowing, lamination process, injection molding, co-injection molding, and combinations thereof. In an exemplary embodiment, the apparatus 604 is a blow molding machine.

A plurality of multilayer preforms 100 can be input along a direction 608 by positioner 212. The positioner 212 may be provided on-line with the input of the apparatus 604. Controller 218 may control the positioner 212 to convey the preforms 100 in direction 608 past the layer sensor 202 for evaluation. Proximity sensor 210 may indicate when the preform is in place for evaluation by the sensor 202.

Processor 602 may receive a fluorescence signal from the layer sensor 202 and may determine the existence of the barrier layer in each preform 100 based on the signal. If the barrier layer is not present, processor 602 may control a rejection device 606 to physically reject a preform without a detected barrier layer from the input path 610 to a rejection path 612. Although shown external to the pathway of the positioner 212, rejection device 606 may be included inline with the positioner 212 so as to effect a pathway re-direction for a preform lacking a barrier layer. Those preforms confirmed to have a barrier layer may be allowed to proceed along path 610 to the input of the manufacturing device 604. Rejection device 606 may be replaced with a marking device for marking preforms without a barrier layer. The manufacturing device 604 may be controlled by a controller 614. Although illustrated as separate components, processor 602, controller 218, and controller 614 may be integrated into a single device.

Further, although the embodiments of FIG. 5 and FIG. 6 have been illustrated separately, the embodiments may be combined together such that testing by the layer sensor 202 occurs on-line in a manufacturing process between the forming of the multilayer preform by manufacturing device 504 and the subsequent processing of the multilayer preform by manufacturing device 604.

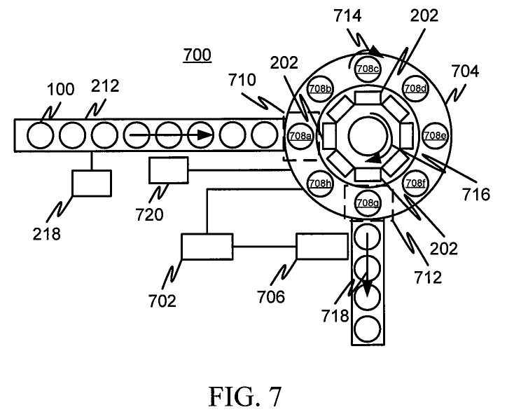

FIG. 7 illustrates an embodiment 700 wherein the layer sensor 202 can be integrated into a test wheel 704. In embodiment 700, multilayer preforms 100 may be conveyed by positioner 212 to the test wheel 704.

Test wheel 704 can have multiple test stations 708a-708h. Each test station may have a respective layer sensor 202 disposed at an interior portion of the test wheel 704. Each test station may also incorporate a positioning means (not shown) for rotating the preform 100 about the axis of the preform, as shown by arrow 714. Each preform may be loaded into a test station, such as test station 708a, at the input position 710. The test wheel 704 may rotate about its axis, as shown by arrow 716, thereby moving the test station 708a and its respective layer sensor 202 around the circumference of the test apparatus 704. Controller 720 may control rotation of the test wheel 704 in direction 716 to allow loading of the test stations 708a-h according to the speed of conveyance by positioner 212.

Concurrent with the rotation of the test wheel 704, the preform loaded into test station 708a may be rotated in direction 714 by the positioning means. Thus, multiple points along the circumference of the preform may be illuminated by the UV light from the layer sensor 202 of test station 708a and the respective fluorescence at each point may be measured by the fluorescence detector of the layer sensor 202 of test station 708a. At least one full rotation of the preform within the test station 708a may be accomplished by the time the test station 708a reaches the output position 712. At the output position, the preform may be removed or ejected from the test apparatus 704 to continue along path 718 for further processing.

Processor 702 can use the fluorescence measured by the fluorescence detector of the layer sensor 202 to determine if the barrier layer exists. Processor 702 may control a marking or rejection device 706 to mark or reject the preform if it is determined not to have a barrier layer. Although shown as separate components, processor 702, controller 218, and controller 720 may be integrated into a single device.

The use of the test wheel 704 in the manner described can enable simultaneous testing of a plurality of points on a plurality of preforms on-line with a conveyance mechanism. Further, the embodiments of FIGS. 5-7 may be combined such that the test wheel 704 is provided on-line with the output of a multilayer preform forming apparatus 504 and with the input to a manufacturing apparatus 604. Although only eight test stations 708a-708h are shown in FIG. 7, additional or fewer test stations may be employed.

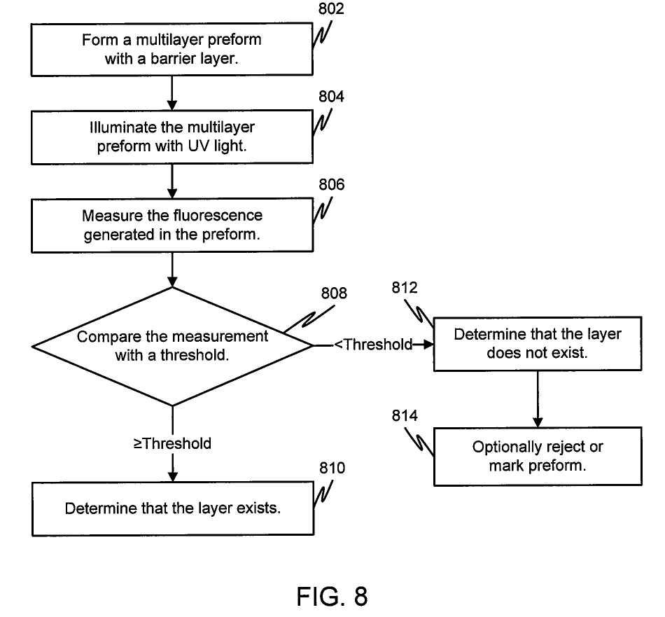

FIG. 8 shows a process flow chart for an exemplary method for forming and testing a multilayer preform. In step 802, a multilayer preform may be formed with at least one barrier layer. The barrier layer may be a polymeric material without any optical brighteners. In an exemplary embodiment, the barrier layer may be a polymeric material selected from polyamides, such as nylon, and ethylene vinyl alcohol copolymers. The multilayer preform may be formed by injection molding. In step 804, the multilayer preform may be illuminated with ultra-violet (UV) light. The UV light can have a wavelength in the UV range sufficient to cause fluorescence of the multilayer preform. In an exemplary embodiment, the UV light may cause detectable fluorescence of the polymeric material of the barrier layer. In step 806, the fluorescence generated by the illumination with the UV light can be measured. The measurement of the fluorescence may then be compared with a predetermined threshold value in step 808. The threshold value may be determined via testing or calibration to prevent false positives or false negatives. If the measured value is greater than or equal to the predetermined threshold, the layer may be determined to exist in step 810. If the measured value is less than the predetermined threshold, the layer may be determined not to exist in step 812. As a result of step 812, the preform may be optionally rejected or marked for subsequent action.

It is, therefore, apparent that there is provided in accordance with the present invention a fabrication method for multilayer preforms and determination of barrier layers in multilayer preforms. While this invention has been described in conjunction with a number of embodiments, it is evident that many alternatives, modifications and variations would be or are apparent to those of ordinary skill in the art. Accordingly, Applicants intend to embrace all such alternatives, modifications, equivalents, and variations that are within the spirit and scope of this invention.

What is claimed is:

1. A fabrication method comprising:
(i) forming a plurality of multilayer preforms using a preform manufacturing apparatus, each preform including at least one barrier layer consisting essentially of a polymeric material without any optical brighteners, said polymeric material selected from polyamides and ethylene vinyl alcohol copolymers;
(ii) providing a test wheel on-line following said preform manufacturing apparatus and on-line preceding a molding apparatus for forming the plurality of multilayer preforms into a plurality of containers,
wherein the test wheel has a plurality of test stations radially disposed around the circumference of the test apparatus,
wherein each test station is configured to receive a multilayer preform for testing,
wherein the test wheel is configured to rotate about its center so as to enable loading and unloading of the plurality of test stations, and
wherein each test station includes positioning means, illumination means, and detection means;
(iii) loading one of the plurality of multilayer preforms into one of the plurality of test stations;
(iv) illuminating said one of the plurality of multilayer preforms with ultra-violet (UV) light from the illumination means;
(v) rotating said one of the plurality of multilayer preforms with respect to the illumination means to expose different portions of the preform;
(vi) measuring at the different portions a magnitude of the fluorescence caused by interaction of the UV light with said one of the plurality of multilayer preforms using the detection means so as to generate a fluorescence signal;
(vii) determining the existence of the barrier layer in said one of the plurality of multilayer preforms based on the fluorescence signal;
(viii) marking or rejecting said one of the plurality of multilayer preforms when the barrier layer is determined not to exist;
(ix) rotating the test wheel to allow loading of a next one of the plurality of test stations with a next one of the plurality of multilayer preforms; and,
(x) repeating steps (iii)-(ix) for each of the plurality of multilayer preforms.

2. The method of claim 1, wherein the step (ix) occurs simultaneously with steps (iv) through (vii).

3. The method of claim 1, wherein the UV light has a wavelength between about 320 nm and 400 nm.

4. The method of claim 1, wherein the fluorescence has a wavelength between about 350 nm and 1000 nm.

5. The method of claim 1, wherein the step (vii) of determining comprises:
comparing the fluorescence signal to a predetermined threshold value;
determining that the barrier layer does not exist when the fluorescence signal is below the predetermined threshold value; and,
determining that the barrier layer does exist when the fluorescence signal is equal to or above the predetermined threshold value.

6. The method of claim 1, wherein said preform manufacturing apparatus is an injection molding machine and said molding apparatus is a blow molding machine.

7. A fabrication method comprising:
forming a multilayer preform containing at least one barrier layer consisting essentially of a polymeric material without any optical brighteners;
illuminating the multilayer preform with UV light;
measuring a magnitude of fluorescence caused by interaction of the UV light with said multilayer preform so as to generate a fluorescence signal;
determining the existence of the barrier layer in the multilayer preform based on the generation of the fluorescence signal.

8. The method of claim 7, wherein the steps of illuminating and measuring occur on-line immediately following the forming of the multilayer preform.

9. The method of claim 7, wherein the steps of illuminating and measuring occur off-line from the forming of the multilayer preform.

10. The method of claim 7, wherein the UV light has a wavelength between about 320 nm and 400 nm.

11. The method of claim 7, wherein the polymeric material is selected from polyamides and ethylene vinyl alcohol copolymers.

12. The method of claim 7, wherein the fluorescence has a wavelength between about 350 nm and 1000 nm.

13. The method of claim 7, further comprising, when the barrier layer is determined to exist, blow-molding the multilayer preform into a container.

14. The method of claim 7, further comprising providing feedback based on the determination of the existence of the barrier layer for use in forming additional multilayer preforms.

15. The method of claim 7, wherein the steps of illuminating, measuring, and determining occur on-line immediately preceding a blow-molding operation configured to form the preform into a container.

16. The method of claim 7, wherein the step of determining comprises:
comparing the fluorescence signal to a predetermined threshold value;
determining that the barrier layer does not exist when the fluorescence signal is below the predetermined threshold value; and,
determining that the barrier layer does exist when the fluorescence signal is equal to or above the predetermined threshold value.

17. The method of claim 7, further comprising, when the barrier layer is determined not to exist, marking the multilayer preform for identification purposes.

18. The method of claim 7, further comprising, when the barrier layer is determined not to exist, rejecting the multilayer preform.

19. The method of claim 7,
wherein the illuminating step includes:
providing a plurality of UV light sources radially disposed around a circumference of the multilayer preform, and
simultaneously illuminating the multilayer preform with UV light from the plurality of UV light sources;
wherein the measuring step includes:
providing a plurality of fluorescence detectors radially disposed around a circumference of the multilayer preform, each fluorescence detector associated with a corresponding one of the plurality of UV light sources, and
simultaneously measuring with each fluorescence detector a magnitude of fluorescence caused by the interaction of UV light from the corresponding UV light source with the multilayer preform, so as to generate a plurality of fluorescence signals; and,
wherein the determining step includes:
determining the existence of the barrier layer based on the generation of the plurality of fluorescence signals.

20. The method of claim 7,
wherein the illuminating step includes:
rotating or translating the preform to expose different portions of the multilayer preform to UV light, and
simultaneously illuminating the multilayer preform with UV light;
wherein the measuring step includes:
measuring at said different portions the magnitude of fluorescence caused by the interaction of UV light with the multilayer preform, so as to generate a plurality of fluorescence signals; and,
wherein the determining step includes:
determining the existence of the barrier layer based on the generation of the plurality of fluorescence signals.
